(19) United States
(12) Patent Application Publication
(10) Pub. No.: US 2011/0151911 A1
(43) Pub. Date: Jun. 23, 2011

(54) MULTIMEDIA BROADCAST/MULTICAST SERVICE SYSTEM, AND DATA TRANSMISSION AND RECEPTION METHOD THEREOF

(75) Inventors: Mi Young YUN, Daejeon (KR); Kyung Sook KIM, Daejeon (KR); Hyun Seo PARK, Daejeon (KR); Sung Gu CHOI, Daejeon (KR); Jung Mo MOON, Daejeon (KR); Sang Ho LEE, Daejeon (KR)

(73) Assignee: Electronics and Telecommunications Research Institute, Daejeon (KR)

(21) Appl. No.: 12/977,413

(22) Filed: Dec. 23, 2010

(30) Foreign Application Priority Data
Dec. 23, 2009 (KR) 10-2009-0129740

(51) Int. Cl. H04B 7/00

(52) U.S. Cl. 455/509

(57) ABSTRACT

A data transmission method of a Multimedia Broadcast/Multicast Service (MBMS) system is provided. The data transmission method includes scheduling multimedia data including a plurality of sub-frames to be transmitted for each of a plurality of scheduling intervals, generating scheduling information, and transmitting, in advance, the scheduling information to a terminal, so that the terminal may selectively receive a plurality of sub-frames corresponding to a first scheduling interval, based on the scheduling information.

### CROSS-REFERENCE TO RELATED APPLICATION

This application claims the benefit of Korean Patent Application No. 10-2009-0129740, filed on Dec. 23, 2009, in the Korean Intellectual Property Office, the disclosure of which is incorporated herein by reference.

### BACKGROUND

1. Field of the Invention

The present invention relates to a Multimedia Broadcast/Multicast Service (MBMS) system, and data transmission and reception method thereof that may enable multimedia data to be selectively received to a terminal based on scheduling information of the multimedia data.

2. Description of the Related Art

In a 3^{rd} Generation Partnership Project (3GPP), the issue of providing audio services and packet services as Multimedia Broadcast/Multicast Services (MBMSs) is being discussed.

An MBMS system may transmit a single piece of multimedia data to a plurality of terminals using a single radio channel on a wireless network. The MBMS system has an advantage in that radio resources may be saved compared to a point-to-point transmission such as a broadcast service.

Additionally, the MBMS system may employ a single cell transmission scheme and a multi-cell transmission scheme in view of a transmitter. Specifically, the single cell transmission scheme may be perform to provide an MBMS to only specific cells so that scheduling of multimedia data may be processed. Here, the scheduling may be performed in a base station (eNodeB). Additionally, the multi-cell transmission scheme may be performed to synchronize and schedule multimedia data in all cells existing in an MBMS area, and to transmit the multimedia data to a terminal. Here, the synchronized multimedia data may be scheduled in a Multi-cell/multicast Coordination Entity (MCE). Accordingly, the terminal may combine the multimedia data received from multiple cells, and may use the combined multimedia data.

The transmitter may transmit, to a terminal, radio bearer setting information via a Multicast Control Channel (MCCH). Accordingly, the terminal may set a radio bearer based on the radio bearer setting information. Subsequently, the terminal may receive radio resource allocation information, via a physical channel, for each sub-frame interval of multimedia data received via a Multicast Traffic Channel (MTCH). The terminal may examine the radio resource allocation information, and may receive sub-frames through a corresponding radio resource. In multicast transmission, various services have common radio resource allocation information, while in unicast transmission, radio resource allocation information is divided for each terminal. In the case of multicast transmission, a terminal needs to determine, for each sub-frame interval via a physical channel, whether information received via the MTCH exists in sub-frames, even when the sub-frames are not required. Accordingly, problems occur, such as a reduction in a receiving speed of the terminal, and an increase in power consumption.

### SUMMARY

An aspect of the present invention provides a Multimedia Broadcast/Multicast Service (MBMS) system, and a data transmission and reception method thereof that may schedule multimedia data for each scheduling interval, and may transmit, to a terminal in advance, scheduling information for each scheduling interval prior to transmitting the multimedia data, so that the terminal may selectively receive sub-frames of the multimedia data by examining the scheduling information.

According to an aspect of the present invention, there is provided a data transmission method of an MBMS system, the data transmission method including: scheduling multimedia data to be transmitted for each of a plurality of scheduling intervals, the multimedia data including a plurality of sub-frames; generating scheduling information for a plurality of sub-frames corresponding to a first scheduling interval among the plurality of scheduling intervals; and transmitting, in advance, the scheduling information to a terminal, mapping radio resource allocation information to each of the plurality of sub-frames corresponding to the first scheduling interval, and transmitting the mapped radio resource allocation information to the terminal, the radio resource allocation information being associated with each of the plurality of sub-frames corresponding to the first scheduling interval, wherein the plurality of sub-frames corresponding to the first scheduling interval are selectively received from the terminal based on the scheduling information.

According to another aspect of the present invention, there is provided a data reception method in an MBMS system, the data reception method including: receiving scheduling information for a plurality of sub-frames corresponding to a first scheduling interval among the plurality of scheduling intervals; and selectively receiving the plurality of sub-frames corresponding to the first scheduling interval based on the scheduling information.

According to another aspect of the present invention, there is provided a data transmission apparatus of an MBMS system, the data transmission apparatus including: a scheduling processor to schedule multimedia data to be transmitted for each of a plurality of scheduling intervals, the multimedia data including a plurality of sub-frames; an information generator to generate scheduling information for the plurality of sub-frames corresponding to each of the plurality of scheduling intervals; and a transmission unit to transmit, to a terminal in advance, scheduling information corresponding to a first scheduling interval among the plurality of scheduling intervals, to map radio resource allocation information to a plurality of sub-frames corresponding to the first scheduling interval, and to transmit the mapped radio resource allocation information to the terminal, the radio resource allocation information being associated with each of the plurality of sub-frames corresponding to the first scheduling interval.

According to another aspect of the present invention, there is provided a data reception apparatus of an MBMS system, the data reception apparatus including: a receiving unit to receive scheduling information for a plurality of sub-frames corresponding to a first scheduling interval among the plurality of scheduling intervals; and a controller to control the receiving unit to selectively receive the plurality of sub-frames corresponding to the first scheduling interval, and radio resource allocation information mapped to each of the plurality of sub-frames corresponding to the first scheduling interval, based on the scheduling information.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a Multimedia Broadcast/Multicast Service (MBMS) system according to embodiments of the present invention;

FIG. 2 is a block diagram illustrating a configuration of the MBMS system of FIG. 1;

FIG. 3 is a diagram illustrating a structure of a radio interface protocol in the MBMS system of FIG. 1;

FIG. 4 is a diagram illustrating a multimedia data transmission structure according to embodiments of the present invention; and

FIG. 5 is a flowchart illustrating a data transmission method of the MBMS system of FIG. 1 according to embodiments of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

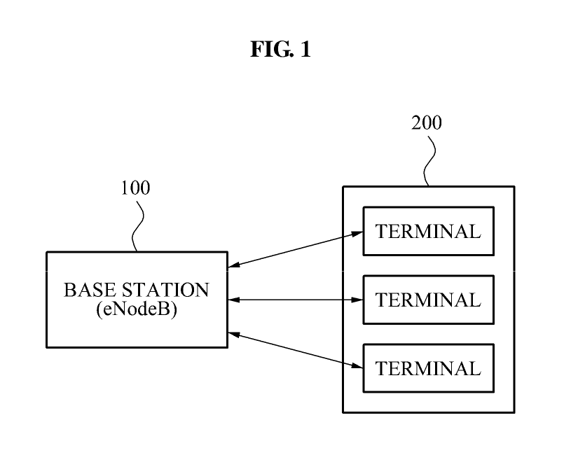

FIG. 1 is a diagram illustrating a Multimedia Broadcast/Multicast Service (MBMS) system according to embodiments of the present invention. Referring to FIG. 1, the MBMS system may include a base station 100 as a transmission apparatus, and a terminal group 200 (hereinafter, referred to as a terminal) including a plurality of terminals as reception apparatus. The base station 100 and the terminal 200 may transmit and receive data through a radio interface protocol. Here, at least one cell may exist in the base station 100.

The base station 100 may transmit multimedia data to the terminal 200. Here, the base station 100 may schedule the multimedia data to be transmitted, prior to transmitting the multimedia data. The scheduling operation may be performed for each scheduling interval. Specifically, the multimedia data may be divided into a first scheduling interval and a second scheduling interval, and may be scheduled for each of a plurality of sub-frames included in each of the first scheduling interval and the second scheduling interval. Here, the first scheduling interval and the second scheduling interval that are consecutive may have variable scheduling intervals, and the variable scheduling intervals may be scheduled in an optional time unit (for example, per several hundreds mille seconds) by which multimedia data is scheduled. While only the first scheduling interval and the second scheduling interval have been described, other consecutive scheduling intervals may further exist.

Multimedia data may include a plurality of sub-frames, and the plurality of sub-frames may be divided for each scheduling interval. Accordingly, the base station 100 may generate scheduling information for a plurality of sub-frames corresponding to the first scheduling interval. Here, the scheduling information may include transmission interval information regarding each of the plurality of sub-frames corresponding to the first scheduling interval, gap information regarding gaps between the plurality of sub-frames corresponding to the first scheduling interval, and length information of a second scheduling interval subsequent to the first scheduling interval.

When the length information of the second scheduling interval is identical to length information of the first scheduling interval, the length information of the second scheduling interval may have a value of ‘0’.

The base station 100 may determine radio resource allocation information to transmit each of the plurality of sub-frames corresponding to the first scheduling interval. Here, the radio resource allocation information may be used to identify frequency bands through which each of the plurality of sub-frames is to be transmitted, and may be defined in a Long Term Evolution (LTE) standard.

When scheduling of a plurality of sub-frames corresponding to each scheduling interval, and generation of scheduling information for the plurality of sub-frames are completed, and when radio resource allocation information is determined, the base station 100 may transmit, to the terminal 200 in advance, scheduling information corresponding to the first scheduling interval, may map the radio resource allocation information to each of the plurality of sub-frames corresponding to the first scheduling interval, and may transmit the mapped radio resource allocation information to the terminal 200. Here, the scheduling information, the plurality of sub-frames, and the radio resource allocation information may be different from each other only in transmission interval (namely, transmission time), and may be transmitted to the terminal 200 in the form of a single piece of data.

The terminal 200 may receive, in advance, the scheduling information corresponding to the first scheduling interval from the base station 100, and may store the received scheduling information. Additionally, based on the stored scheduling information, the terminal 200 may examine, in advance, an interval where each of the plurality of sub-frames corresponding to the first scheduling interval is transmitted. When a desired sub-frame exists among the plurality of sub-frames, the terminal 200 may initiate a receiving operation in an interval where the desired sub-frame is transmitted, and may selectively receive the desired sub-frame. Accordingly, the terminal 200 may receive a desired sub-frame only in an interval where the desired sub-frame is transmitted, without a need to consume power to receive unnecessary sub-frames.

When the plurality of sub-frames corresponding to the first scheduling interval are completely transmitted, the base station 100 may transmit, to the terminal 200 in advance, scheduling information corresponding to a second scheduling interval, and may transmit, to the terminal 200, a plurality of sub-frames corresponding to the second scheduling interval and radio resource allocation information corresponding to the second scheduling interval. Accordingly, the terminal 200 may receive the scheduling information corresponding to the second scheduling interval, and may selectively receive the plurality of sub-frames corresponding to the second scheduling interval based on the received scheduling information. In a similar manner, scheduling intervals subsequent to the second scheduling interval may be processed.

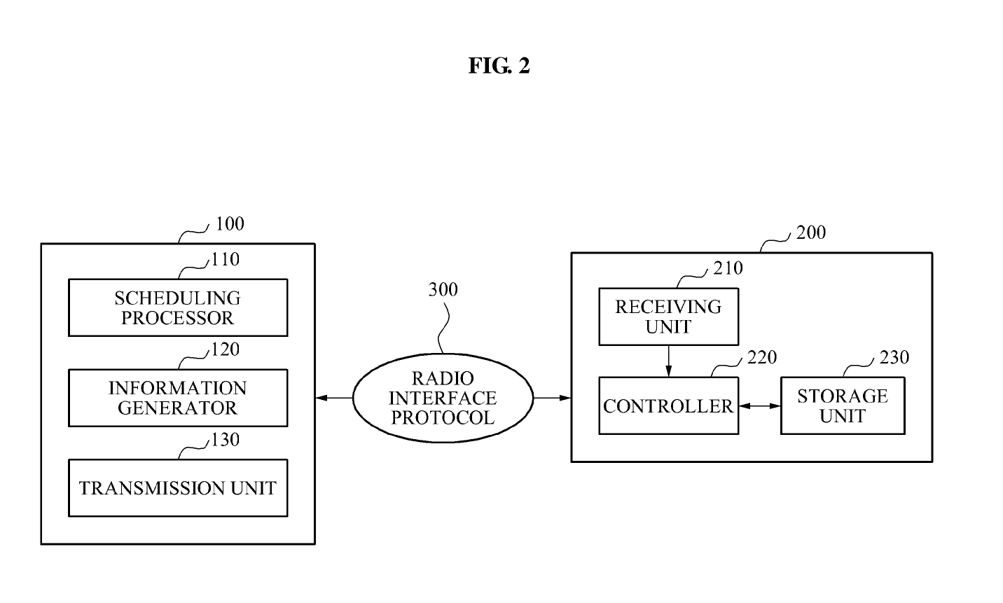

FIG. 2 is a block diagram illustrating a configuration of the MBMS system of FIG. 1. Referring to FIG. 2, the base station 100 may transmit or receive data to or from the terminal 200 via a radio interface protocol 300.

First, the base station 100 may be used as a transmission apparatus to transmit multimedia data for an MBMS to the terminal 200, and may include a scheduling processor 110, an information generator 120, and a transmission unit 130.

The scheduling processor 110 may schedule multimedia data including a plurality of sub-frames. Specifically, the scheduling operation may be performed for each scheduling interval, for example, a first scheduling interval, a second scheduling interval, and consecutive scheduling intervals subsequent to the second scheduling interval. Here, the first scheduling interval and the second scheduling interval may have the same length or different lengths.

The information generator 120 may generate scheduling information for a plurality of sub-frames corresponding to each of the plurality of scheduling intervals, in connection with the scheduling processor 110. The information generator 120 may be implemented as a Media Access Control (MAC) Element.

The scheduling information may include transmission interval information regarding each of a plurality of sub-frames corresponding to a predetermined scheduling interval, gap information regarding gaps between the plurality of sub-frames corresponding to the predetermined scheduling interval, and length information of a scheduling interval subsequent to the predetermined scheduling interval. Length information of a subsequent scheduling interval may vary depending on whether the length information is identical to length information of a previous scheduling interval. For example, when length information of a second scheduling interval subsequent to a first scheduling interval is identical to length information of the first scheduling interval, the length information of the second scheduling interval may have a value of ‘0’. In other words, when the length information of the second scheduling interval has values other than ‘0’, the first scheduling interval and the second scheduling interval may have different lengths.

The transmission unit 130 may transmit, to the terminal 200, radio bearer setting information for setting a point-to-multipoint radio bearer. Additionally, the transmission unit 130 may transmit the scheduling information to the terminal 200 in advance, so that the terminal 200 may examine the scheduling information in advance, prior to transmitting the plurality of sub-frames. Here, scheduling information for a plurality of sub-frames corresponding to a predetermined scheduling interval may be transmitted to the terminal 200 via the MAC element.

The transmission unit 130 may map a plurality of sub-frames corresponding to a predetermined scheduling interval to radio resource allocation information that is associated with each of the plurality of sub-frames, and may transmit the mapped radio resource allocation information to the terminal 200. Here, the radio resource allocation information may be defined in the LTE standard, and may be transmitted to the terminal 200 via a Physical Downlink Control Channel (PDCCH) that is a physical channel of the radio interface protocol 300.

The terminal 200 may be used as a reception apparatus to receive data from the base station 100, and may include a receiving unit 210, a controller 220, and a storage unit 230.

The receiving unit 210 may receive radio bearer setting information via the radio interface protocol 300. The receiving unit 210 may also receive scheduling information for scheduling intervals via the radio interface protocol 300. For example, the receiving unit 210 may receive scheduling information corresponding to a first scheduling interval, and the received scheduling information may be stored in the storage unit 230.

The receiving unit 210 may selectively receive a plurality of sub-frames corresponding to a predetermined scheduling interval via the radio interface protocol 300.

When the scheduling information is received by the receiving unit 210, the controller 220 may transfer the received scheduling information to the storage unit 230, so that the storage unit 230 may store the scheduling information, and the controller 220 may selectively receive a plurality of sub-frames corresponding to the first scheduling interval based on the scheduling information. Specifically, the controller 220 may examine the transmission interval information included in the scheduling information, to verify a time at which each of the plurality of sub-frames corresponding to the predetermined scheduling interval is transmitted. Accordingly, the controller 220 may determine whether each of the plurality of sub-frames is required, and may initiate a receiving operation in an interval where a sub-frame determined to be required is transmitted, so that the required sub-frame may be selectively received.

Additionally, when a plurality of sub-frames corresponding to a predetermined scheduling interval are selectively received as described above, the controller 220 may repeatedly perform the above-described operations with respect to subsequent scheduling intervals. For example, when a plurality of sub-frames corresponding to a first scheduling interval are selectively received, the controller 220 may receive scheduling information corresponding to a second scheduling interval through the receiving unit 210, and may selectively receive a plurality of sub-frames corresponding to the second scheduling interval.

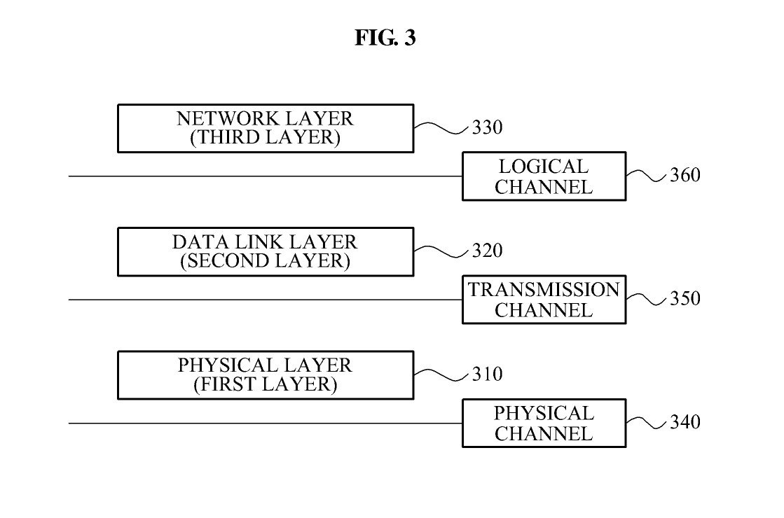

FIG. 3 is a diagram illustrating a structure of the radio interface protocol 300 in the MBMS system of FIG. 1. Referring to FIG. 3, the radio interface protocol 300 between the base station 100 and the terminal 200 may be divided into a first layer (L1), a second layer (L2), and a third layer (L3) based on lower three layers of an Open System Interconnection (OSI) standard model in a communication system. Additionally, a physical channel 340, a transmission channel 350, and a logical channel 360 may be formed to connect the first layer (L1), the second layer (L2), and the third layer (L3).

A physical layer 310 as the first layer L1 may provide an information transfer service to an upper layer using the physical channel 340. Additionally, the physical layer 310 may be connected to a data link layer 320 above the physical layer 310, via the transmission channel 350. Furthermore, the data link layer 320 may include a MAC layer, and a Radio Link Control (RLC) layer that is located above the MAC layer. Data may be transferred between the data link layer 320 and the physical layer 310 via the transmission channel 350.

The data link layer 320 as the second layer L2 may provide an RLC service to the RLC layer above the MAC layer via the logical channel 360. The RLC layer of the second layer L2 may support reliable data transfer, and may be operative in segmentation and concatenation of RLC Service Data Units (SDUs) sent down from an upper layer.

A Radio Resource Control (RRC) layer as the third layer (L3) may control the logical channel 360, the transmission channel 350, and the physical channel 340 with setting, resetting, and release of radio bearers.

The physical channel 340, the transmission channel 350 and the logical channel 360 formed among the first layer (L1), the second layer (L2) and the third layer (L3) may be mapped to each other. Specifically, the physical channel 340 may be used to transmit radio resource allocation information to the terminal 200, and may include a PDCCH. The PDCCH may be mapped to the transmission channel 350, for example a Multicast Channel (MCH) or a Downlink-Shared Channel (DL-SCH). Additionally, the MCH or the DL-SCH may be mapped to the logical channel 360, for example a Multicast Control Channel (MCCH) or a Multicast Traffic Channel (MTCH).

The MCCH as the logical channel 360 may be used to transmit MCCH information from the base station 100 to the terminal 200. Here, the MCCH information may include an RRC message associated with the MBMS. The MCCH information may include, for example, a message indicating MBMS information, a message indicating point-to-multipoint radio bearer setting information, and a message indicating that RRC connection for the MBMS is requested. The MCCH information may be periodically transmitted based on a modification period and a repetition period, and may be modified based on generation, modification or removal of the MBMS.

The base station 100 as a transmission apparatus may transmit multimedia data to the terminal 200 via an MCCH and an MTCH. Here, a plurality of MTCHs may exist, and the MCCH and the MTCH may be mapped to a DL-SCH or an MCH. Additionally, the DL-SCH or the MCH may be mapped to a physical channel, for example a Physical Downlink Shared Channel (PDSCH), and a Physical Multicast Channel (PMCH).

Additionally, an MTCH as a logical channel may be used to transmit multimedia data for an MBMS. Accordingly, the base station 100 may transmit a plurality of sub-frames corresponding to each scheduling interval, via the MTCH.

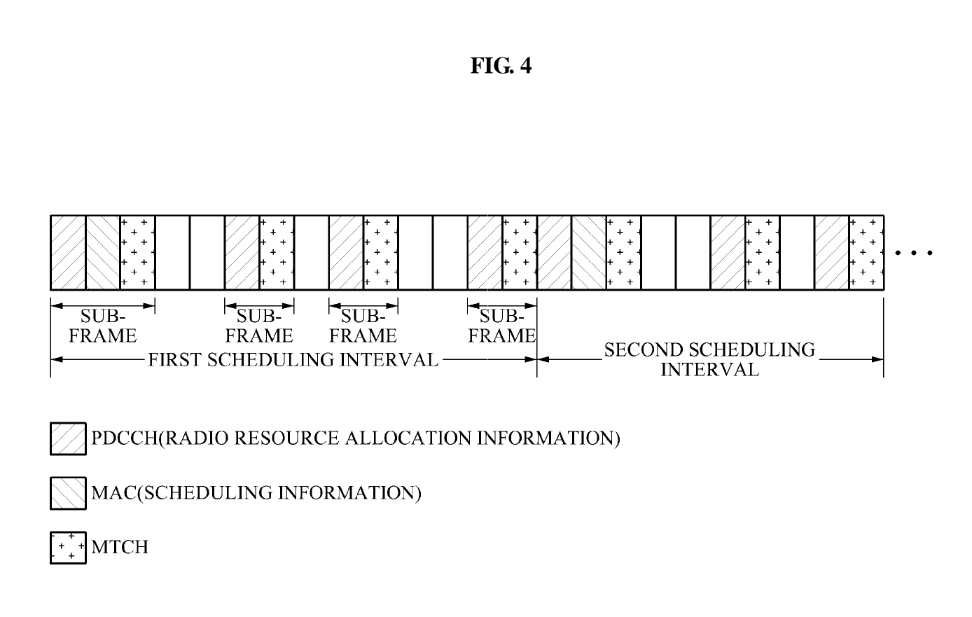

FIG. 4 is a diagram illustrating a multimedia data transmission structure according to embodiments of the present invention. Referring to FIG. 4, the base station 100 may schedule multimedia data for each scheduling interval, and may transmit, to the terminal 200, scheduling information, and a plurality of sub-frames to which radio resource allocation information is mapped.

As shown in FIG. 4, the plurality of sub-frames forming the multimedia data may be grouped into a first scheduling interval and a second scheduling interval, and a plurality of sub-frames corresponding to each of the scheduling intervals may be scheduled.

In FIG. 4, scheduling information may be included in a first sub-frame in the first scheduling interval, and may be transmitted. Specifically, the scheduling information may be transmitted in advance to the terminal 200, so that the terminal 200 may examine, in advance, transmission interval information regarding each of the plurality of sub-frames.

The radio resource allocation information for each of the plurality of sub-frames may be located in a front portion of each sub-frame, and may be transmitted. Here, the radio resource allocation information may be information regarding radio resources used when each sub-frame is transmitted, and may be transmitted to the terminal 200 via a PDCCH.

As shown in FIG. 4, the first sub-frame of the first scheduling interval may include the scheduling information and the radio resource allocation information, and sub-frames subsequent to the first sub-frame may include radio resource allocation information. Here, each of the sub-frames may have a length of ‘1’ meter/second (ms).

The scheduling information may further include length information of the second scheduling interval subsequent to the first scheduling interval, in addition to transmission interval information regarding each of the plurality of sub-frames corresponding to the first scheduling interval, and gap information regarding gaps between the plurality of sub-frames corresponding to the first scheduling interval. Here, when the first scheduling interval and the second scheduling interval have the same length, the length information of the second scheduling interval may have a value of ‘0’. Conversely, when the first scheduling interval and the second scheduling interval have different lengths, the length information of the second scheduling interval may have values other than ‘0’.

The terminal 200 may examine a transmission interval for the plurality of sub-frames, based on the scheduling information corresponding to the first scheduling interval, may initiate a receiving operation in an interval where a desired sub-frame is transmitted, and may selectively receive the desired sub-frame. When the first scheduling interval ends, the terminal 200 may receive a plurality of sub-frames corresponding to the second scheduling interval.

A plurality of sub-frames included in each of the scheduling intervals may have a fixed length, or a variable length within a predetermined scheduling interval. For example, when the plurality of sub-frames included in the first scheduling interval have a fixed length, locations and lengths of the plurality of sub-frames in the first scheduling interval may be identical to each other, and the same radio resource may be allocated to each of the plurality of sub-frames in the first scheduling interval. Accordingly, the terminal 200 may recognize, in advance, the radio resource allocation information for each of the plurality of sub-frames in the first scheduling interval and thus, may selectively receive desired sub-frames without receiving the PDCCH to acquire the radio resource allocation information for each of the sub-frames.

Conversely, even when the plurality of sub-frames included in the first scheduling interval have different lengths, the terminal 200 may selectively receive the sub-frames, since the terminal 200 already recognizes an interval where each of the sub-frames is transmitted, based on the scheduling information. Accordingly, the terminal 200 may initiate the receiving operation only in an interval where a desired sub-frame is transmitted, without a need to receive all of the plurality of sub-frames in each of the scheduling intervals, so that power consumption may be reduced.

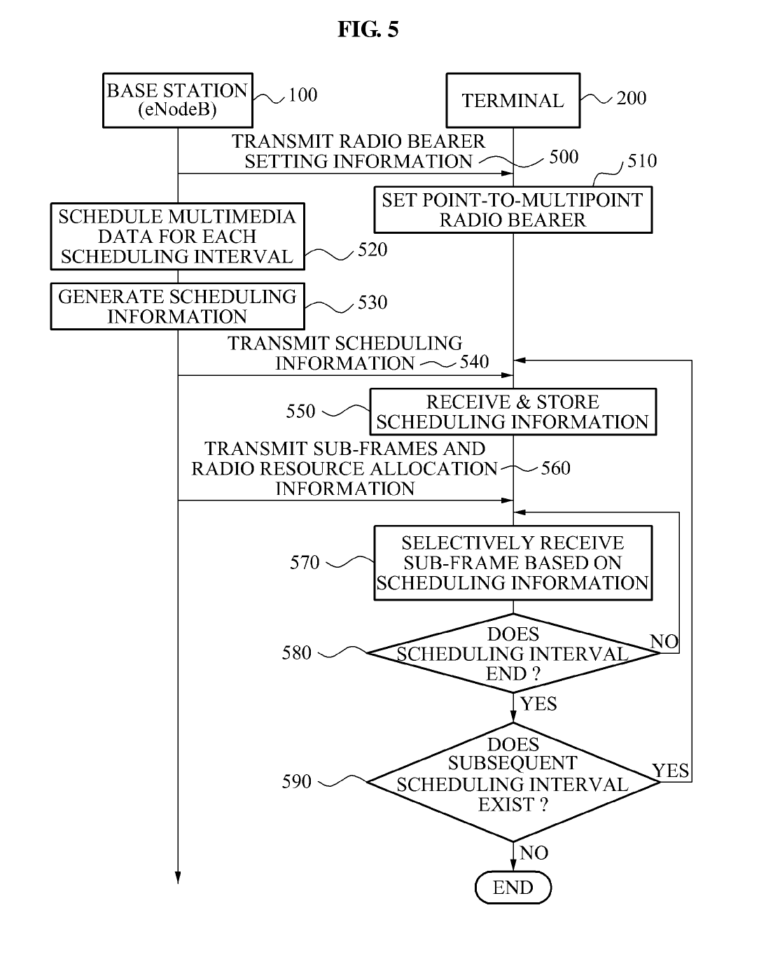

FIG. 5 is a flowchart illustrating a data transmission method of the MBMS system of FIG. 1 according to embodiments of the present invention. In operation 500, the base station 100 may transmit, to the terminal 200, radio bearer setting information for setting a point-to-multipoint radio bearer.

In operation 510, the terminal 200 may receive the radio bearer setting information, and may set the point-to-multipoint radio bearer.

When the point-to-multipoint radio bearer is set by the terminal 200, the base station 100 may schedule multimedia data for each scheduling interval in operation 520. Specifically, the multimedia data may be divided into a plurality of scheduling intervals, and each of a plurality of sub-frames included in each of the scheduling intervals may be scheduled.

When operation 520 is completed, the base station 100 may generate scheduling information corresponding to each of the plurality of scheduling intervals in operation 530. In operation 540, the base station 100 may transmit, to the terminal 200, first scheduling information corresponding to a first scheduling interval among the plurality of scheduling intervals. In operation 550, the terminal 200 may receive the first scheduling information, and may store the received scheduling information.

In operation 560, the base station 100 may transmit, to the terminal 200, radio resource allocation information corresponding to the first scheduling interval and a plurality of sub-frames corresponding to the first scheduling interval. Here, the radio resource allocation information may be associated with each of the plurality of sub-frames, and may be located in a front portion of each of the plurality of sub-frames.

In operation 570, the terminal 200 may selectively receive a desired sub-frame based on the first scheduling information. Specifically, the terminal 200 may examine transmission interval information regarding each of the plurality of sub-frames corresponding to the first scheduling information, and may initiate a receiving operation in an interval where the desired sub-frame is transmitted, to selectively receive the desired sub-frame, instead of receiving all of the plurality of sub-frames transmitted from the base station 100. In other words, the terminal 200 may perform a receiving operation only when a desired sub-frame exists. Thus, it is possible to reduce power consumption caused by data reception.

In operation 580, the terminal 200 may determine whether the first scheduling interval ends. When the first scheduling interval ends, the terminal 200 may verify whether a subsequent scheduling interval exists in operation 590. Operation 590 may be performed based on the scheduling information corresponding to the first scheduling interval, because the scheduling information includes length information of a second scheduling interval subsequent to the first scheduling interval. In other words, when the length information of the second scheduling interval is included in the scheduling information, the terminal 200 may determine that the subsequent second scheduling interval exists.

When the subsequent second scheduling interval is verified to exist, the terminal 200 may repeatedly perform operations 540 through 580. Specifically, the terminal 200 may repeatedly perform receiving of second scheduling information corresponding to the subsequent second scheduling interval from the base station 100, and selectively receiving of a plurality of sub-frames based on the second scheduling information.

As described above, according to embodiments of the present invention, multimedia data may be scheduled for each scheduling interval, and scheduling information for each scheduling interval may be transmitted to a terminal in advance, prior to transmitting the multimedia data, so that the terminal may verify scheduling information of a predetermined scheduling interval. Accordingly, the terminal may selectively receive sub-frames of the multimedia data and thus, a receiving speed of the terminal may be increased, and power consumption may be reduced.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A data transmission method of a Multimedia Broadcast/Multicast Service (MBMS) system, the data transmission method comprising:
scheduling multimedia data to be transmitted for each of a plurality of scheduling intervals, the multimedia data comprising a plurality of sub-frames;
generating scheduling information for a plurality of sub-frames corresponding to a first scheduling interval among the plurality of scheduling intervals; and
transmitting, in advance, the scheduling information to a terminal, mapping radio resource allocation information to each of the plurality of sub-frames corresponding to the first scheduling interval, and transmitting the mapped radio resource allocation information to the terminal, the radio resource allocation information being associated with each of the plurality of sub-frames corresponding to the first scheduling interval,
wherein the plurality of sub-frames corresponding to the first scheduling interval are selectively received from the terminal based on the scheduling information.

2. The data transmission method of claim 1, wherein the transmitting comprises:
transmitting the scheduling information to the terminal via a Media Access Control (MAC) layer;
transmitting the radio resource allocation information to the terminal via a Physical Downlink Control Channel (PDCCH); and
transmitting the plurality of sub-frames corresponding to the first scheduling interval to the terminal via a Multicast Traffic channel (MTCH) mapped with the PDCCH.

3. The data transmission method of claim 1, wherein the scheduling information comprises transmission interval information regarding each of the plurality of sub-frames corresponding to the first scheduling interval, gap information regarding gaps between the plurality of sub-frames corresponding to the first scheduling interval, and length information of a second scheduling interval subsequent to the first scheduling interval.

4. The data transmission method of claim 3, wherein the length information of the second scheduling interval has a value of ‘0’ when the length information of the second scheduling interval is identical to length information of the first scheduling interval.

5. The data transmission method of claim 1, further comprising:
transmitting radio bearer setting information to the terminal via a Multicast Control Channel (MCCH), and setting, by the terminal, a point-to-multipoint radio bearer.

6. A data reception method of receiving multimedia data to be transmitted for each of a plurality of scheduling intervals, in an MBMS system, the data reception method comprising:
receiving scheduling information for a plurality of sub-frames corresponding to a first scheduling interval among the plurality of scheduling intervals; and
selectively receiving the plurality of sub-frames corresponding to the first scheduling interval based on the scheduling information.

7. The data reception method of claim 6, further comprising:
receiving the scheduling information and storing the scheduling information.

8. The data reception method of claim 6, further comprising:
receiving radio bearer setting information via an MCCH; and
setting a point-to-multipoint radio bearer based on the radio bearer setting information.

9. The data reception method of claim 6, wherein the scheduling information comprises transmission interval information regarding each of the plurality of sub-frames corresponding to the first scheduling interval, gap information regarding gaps between the plurality of sub-frames corresponding to the first scheduling interval, and length information of a second scheduling interval subsequent to the first scheduling interval.

10. The data reception method of claim 6, further comprising:
receiving scheduling information for a plurality of sub-frames corresponding to a second scheduling interval among the plurality of scheduling intervals, when the selectively receiving is completed; and
selectively receiving the plurality of sub-frames corresponding to the second scheduling interval based on the scheduling information.

11. A data transmission apparatus of an MBMS system, the data transmission apparatus comprising:
a scheduling processor to schedule multimedia data to be transmitted for each of a plurality of scheduling intervals, the multimedia data comprising a plurality of sub-frames;
an information generator to generate scheduling information for the plurality of sub-frames corresponding to each of the plurality of scheduling intervals; and
a transmission unit to transmit, to a terminal in advance, scheduling information corresponding to a first scheduling interval among the plurality of scheduling intervals, to map radio resource allocation information to a plurality of sub-frames corresponding to the first scheduling interval, and to transmit the mapped radio resource allocation information to the terminal, the radio resource allocation information being associated with each of the plurality of sub-frames corresponding to the first scheduling interval.

12. The data transmission apparatus of claim 11, wherein the scheduling information comprises transmission interval information regarding each of the plurality of sub-frames corresponding to the first scheduling interval, gap information regarding gaps between the plurality of sub-frames corresponding to the first scheduling interval, and length information of a second scheduling interval subsequent to the first scheduling interval.

13. The data transmission apparatus of claim 12, wherein the length information of the second scheduling interval has a value of ‘0’ when the length information of the second scheduling interval is identical to length information of the first scheduling interval.

14. The data transmission apparatus of claim 11, wherein the transmission unit is wirelessly connected to the terminal through a radio interface protocol structure, and
wherein the radio interface protocol structure comprises:
a MAC layer to transmit the scheduling information to the terminal;
a PDCCH to transmit the radio resource allocation information to the terminal; and
an MTCH to transmit, to the terminal, the plurality of sub-frames corresponding to the first scheduling interval, the MTCH being mapped with the PDCCH.

15. The data transmission apparatus of claim 14, wherein the radio interface protocol structure further comprises an MCCH to transmit radio bearer setting information to the terminal so that the terminal sets a point-to-multipoint radio bearer.

16. The data transmission apparatus of claim 11, wherein the transmission unit transmits, to the terminal in advance, scheduling information corresponding to a second scheduling interval, maps the radio resource allocation information to a plurality of sub-frames corresponding to the second scheduling interval, and transmits the mapped radio resource allocation information to the terminal, when the plurality of sub-frames corresponding to the first scheduling interval are completely transmitted.

17. A data reception apparatus for receiving multimedia data that is scheduled to be transmitted for each of a plurality of scheduling intervals and comprises a plurality of sub-frames, in an MBMS system, the data reception apparatus comprising:
a receiving unit to receive scheduling information for a plurality of sub-frames corresponding to a first scheduling interval among the plurality of scheduling intervals; and
a controller to control the receiving unit to selectively receive the plurality of sub-frames corresponding to the first scheduling interval, and radio resource allocation information mapped to each of the plurality of sub-frames corresponding to the first scheduling interval, based on the scheduling information.

18. The data reception apparatus of claim 17, further comprising:
a storage unit to store the received scheduling information.

19. The data reception apparatus of claim 17, wherein the receiving unit receives radio bearer setting information via an MCCH, and
wherein the controller sets a point-to-multipoint radio bearer based on the radio bearer setting information.
